(19) United States
(12) Patent Application Publication
(10) Pub. No.: US 2014/0278874 A1
(43) Pub. Date: Sep. 18, 2014

(54) SYSTEMS AND METHODS FOR PROMOTING DAILY DEALS

(71) Applicants: Louis Lamoureux, Hinsdale, IL (US); Serene Hope, San Ramon, CA (US)

(72) Inventors: Louis Lamoureux, Hinsdale, IL (US); Serene Hope, San Ramon, CA (US)

(21) Appl. No.: 13/840,719

(22) Filed: Mar. 15, 2013

(51) Int. Cl. G06Q 30/02

(52) U.S. Cl. CPC G06Q 30/0221
USPC 705/14.22

(57) ABSTRACT

Systems and methods provide a variety of ways in which to generate and promote multi-merchant deals spanning multiple geographical regions and/or multiple industries. In deals involving merchants from two or more industries, customers may be provided with one ticket per person per industry. Any goods and/or services provided by the merchants from different industries are not intertwined with one another so as to form one experience. Further, in deals involving merchants from the same industry, the customer may be provided with a choice as to which merchant to redeem the goods and/or services. Likewise, in some examples, the customer may choose in which geographical region to receive the goods and/or services.

### FIELD OF DISCLOSURE

The present disclosure relates generally to organizing deals and, more particularly, to systems and methods for promoting daily deals.

### BACKGROUND

In the art it is known that most daily deals nowadays involve a single merchant and a single daily deal firm. More recently, merchants have started using more than one daily deal firm. As a result, these merchants have customers coming to their businesses, whether it be a physical location or online, with coupons from a number of daily deal firms. These coupons, moreover, generally differ in appearance from one another. Thus the merchant must train its staff to accept all these different coupons. Further, to record that these coupons have been redeemed, the merchant's staff needs to log into each daily deal firm's coupon management system. Likewise, for daily deal firms that run daily deals involving multiple merchants, the daily deal firm needs to establish relationships with the multiple merchants and organize a deal that meets the needs of the multiple merchants. While this task is somewhat feasible for the largest daily deal firms, most daily deal firms do not have relationships in place to run such a business.

As a result, promoters of daily deals have come into the daily deal business. In general, promoters serve to interface between merchants and daily deal firms. Promoters are typically companies that organize deals on behalf of one or more merchants and, in some instances, market daily deals directly to potential customers. In other instances, promoters use one or more daily deal firms to market daily deals to potential customers. Therefore, by using a promoter, a merchant need only interface with the promoter or the promoter's website rather than a number of daily deal firms. Likewise, where a daily deal firm uses a promoter, the daily deal firm need not interface with a multitude of merchants.

Once a customer purchases a coupon for a daily deal from a daily deal firm, the customer takes the coupon to the promoter's website to redeem one or more tickets that can be taken to the merchant in exchange for goods or services. In some cases, the customer enters an email address and a coupon code associated with the coupon at the promoter's website, which allows the website to verify that the coupon is valid. Thereafter, the website emails the tickets or a link to the tickets to the customer. Such websites allow for the promoter to display deal-specific text on the tickets. Further, a promoter's website may list deals that the merchant participated in and the number of tickets that were redeemed for each deal at that merchant. Such websites also permit merchants to send an email to customers that redeemed tickets at their location.

Still further, it is known in the art to structure daily deals such that the customer receives a single coupon or a single ticket for one experience involving two industries, such as horseback riding at a winery provided by a first merchant followed by wine tasting at the winery provided by a second merchant.

### BRIEF DESCRIPTION OF THE DRAWINGS

For a better understanding of the described systems and methods for promoting daily deals, reference may be had to examples shown in the following drawings in which:

FIG. 1 is a block diagram illustrating components of an example network system in which the disclosed methods may be employed;

FIG. 2 is a block diagram illustrating a model in which a website associated with a promoter serves as an interface between a plurality of merchants and a plurality of daily deal firms;

FIG. 3 is a flow chart illustrating several high-level steps that can occur within a life of a daily deal;

FIG. 4 is a flow chart illustrating an example process by which a daily deal can be created through an example website;

FIG. 5 is a flow chart illustrating an example process by which an example website may be utilized to redeem coupons for tickets; and

FIG. 6 is a flow chart illustrating an example process by which a customer-specific, industry-specific, region-specific ticket may be generated by an example website.

FIG. 7 illustrates an example merchant interface showing information based on one or more deals in which a merchant has participated.

FIG. 8 illustrates an example promoter interface showing information based on one or more deals that a promoter organized.

### DETAILED DESCRIPTION

Disclosed hereinafter are systems and methods that can be used to generate and promote multi-merchant deals, some of which are daily deals. Some of the deals may involve merchants from more than one geographical region, while other deals may involve merchants from more than one industry. Still other deals may involve both merchants from different geographical regions and merchants from different industries. Yet further deals involve at least two merchants that are unrelated but are from the same geographical area and from the same industry. Merchants that are unrelated may be independently owned and associated with different brands, for example.

As part of the example systems disclosed below, a website is provided for merchants, promoters, and customers involved in one or more deals. In particular, the website may generally help promoters identify merchants and organize the terms of a deal. Further, the website may help customers redeem a coupon purchased from a daily deal firm for a ticket redeemable at participating merchants, for instance. The website may also help merchants, for example, verify the validity of tickets, record which tickets have been redeemed, and track statistics associated with daily deals.

While the foregoing generally disclose systems and methods for generating and promoting daily deals, a better understanding of the objects, advantages, features, properties, and relationships of the systems and methods will be obtained from the following detailed description and accompanying drawings which set forth illustrative examples which are indicative of the various ways in which the principles of the disclosure may be employed.

As illustrated in FIG. 1, a system 100 will be described in the context of a plurality of processing devices 102 linked via a network 104, such as the World Wide Web or the Internet. In this regard, a user processing device 102′ illustrated in the example form of a computer system, a user processing device 102″ illustrated in the example form of a mobile device, or a user processing device 102′″ illustrated in the example form of a personal computer provide a means for a user to access a website content server 106 via the network 104 and thereby gain access to content such as media, data, webpages, an electronic catalog, etc., stored in a repository 108 associated with the content server 106. Although only one of the processing devices 102 is shown in detail in FIG. 1, it will be understood that in some examples the user processing device 102′ shown in detail may be representative, at least in part, of the other user processing devices 102″, 102′″, including those that are not shown.

Furthermore, the website content server 106 and/or the user processing devices 102 allow users to read and/or write data to the website content server 106. As described below, users may include promoters, daily-deal firms, merchants, and/or customers, for example. A user's interactions with the content offered by a website are stored in the repository 108 associated with the content server 106 and are further indexed to a particular user. Storing such information can be accomplished, for example, by using log-in credentials and/or other information that the content server 106 may utilize to identify the user. In still other examples, the user's interactions with the content offered by the website may be stored on the user processing devices 102 in cases where a user has not logged into the website content server 106 and is anonymously navigating the content provided by the website content server 106. In this case, users' interactions with the web content offered by the website content server 106 may be stored, for example, in cookies placed on the user processing devices 102 using well known techniques. Since the manner by which the user processing devices 102 are used to access and navigate the website offered by the website content server 106, the manner by which the website content server 106 makes content available to the user devices 102, and the manner by which the website usage is monitored are all well known in the art, they will not be discussed further herein for the sake of brevity.

For performing the functions required of the user processing devices 102 and the content server 106, the user processing devices 102 and the content server 106 include computer executable instructions that reside in program modules stored on any non-transitory computer readable storage medium that may include may include routines, programs, objects, components, data structures, etc. that perform particular tasks or implement particular abstract data types. Accordingly, one of ordinary skill in the art will appreciate that the user processing devices 102 and the content server 106 may be any device having the ability to execute instructions such as, by way of example, a personal computer, mainframe computer, personal-digital assistant (PDA), tablet, cellular telephone, mobile device, e-reader, or the like. Furthermore, while the user processing devices 102 and the content server 106 within the system 100 are illustrated as respective single devices, those having ordinary skill in the art will also appreciate that the various tasks described hereinafter may be practiced in a distributed environment involving multiple processing devices linked via a local or wide-area network whereby the executable instructions may be associated with and/or executed by one or more of multiple processing devices.

More particularly, the user processing device 102′, which may be representative of all user processing devices 102 and the content server 106 illustrated in FIG. 1, performs various tasks in accordance with the executable instructions. Thus the example user processing device 102′ includes one or more processing units 110 and a system memory 112, which may be linked via a bus 114. Without limitation, the bus 114 may be a memory bus, a peripheral bus, and/or a local bus using any of a variety of well-known bus architectures. As needed for any particular purpose, the example system memory 112 includes read only memory (ROM) 116 and/or random access memory (RAM) 118. Additional memory devices may also be made accessible to the processing device 102′ by means of, for example, a hard disk drive interface 120, a removable magnetic disk drive interface 122, and/or an optical disk drive interface 124. As will be understood, these devices, which may be linked to the system bus 114, respectively allow for reading from and writing to a hard drive 126, reading from or writing to a removable magnetic disk 128, and for reading from or writing to a removable optical disk 130, such as a CD/DVD ROM or other optical media. The drive interfaces and their associated tangible, computer-readable media allow for the nonvolatile storage of computer readable instructions, data structures, program modules and other data for the user processing device 102′. Those of ordinary skill in the art will further appreciate that other types of tangible, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 132, containing the basic routines that help to transfer information between elements within the user processing device 102′, such as during start-up, may be stored in the ROM 116. Similarly, the RAM 118, the hard drive 126, and/or the peripheral memory devices may be used to store computer executable instructions comprising an operating system 134, one or more applications programs 136 (such as a Web browser), other program modules 138, and/or program data 140. Still further, computer-executable instructions may be downloaded to one or more of the computing devices as needed, for example, via a network connection.

A user may enter commands and information into the user processing device 102′ through input devices such as a keyboard 142 and/or a pointing device 144 (e.g., a computer mouse). While not illustrated, other input devices may include for example a microphone, a joystick, a game pad, a scanner, a touchpad, a touch screen, a motion sensing input, etc. These and other input devices may be connected to the processing unit 110 by means of an interface 146 which, in turn, may be coupled to the bus 114. Input devices may be connected to the processor 110 using interfaces such as, for example, a parallel port, game port, firewire, universal serial bus (USB), or the like. To receive information from the user processing device 102′, a monitor 148 or other type of display device may also be connected to the bus 114 via an interface, such as a video adapter 150. In addition to the monitor 148, the user processing device 102′ may also include other peripheral output devices such as a speaker 152.

As further illustrated in FIG. 1, the example user processing device 102′ has logical connections to one or more remote computing devices, such as the content server 106 which, as noted above, may include many or all of the elements described above relative to the user processing device 102′ as needed for performing its assigned tasks. By way of further example, the website content server 106 may include executable instructions stored on a non-transient memory device for, among other things, presenting webpages, handling search requests, providing search results, providing access to context related services, redeeming coupons, sending emails, managing lists, managing databases, generating tickets, presenting requested user specific information, generating deals, etc. Communications between the user processing device 102′ and the content server 106 may be exchanged via a further processing device, such as a network router (not shown), that is responsible for network routing. Communications with the network router may be performed via a network interface component 154. Thus within such a networked environment (e.g., the Internet, World Wide Web, LAN, or other like type of wired or wireless network), it will be appreciated that program modules depicted relative to the user processing device 102′, or portions thereof, may be stored in the repository 108 of the content server 106. Additionally, it will be understood that, in certain circumstances, various data of the application and/or data utilized by the content server 106 and/or the user processing device 102′ may reside in the “cloud.”

As described above, users of the system 100 may include merchants, customers, promoters, daily deal firms, and the like in the daily deal space. Promoters are companies that organize deals on behalf of merchants and, in some instances, market the deal to potential customers. And in those instances, a promoter essentially plays, amongst other roles, the role of a daily deal firm. Further, it should be understood that even though this disclosure uses the term “daily deal,” nothing about the term is necessarily limited to one day. Rather, “daily deal” has become a term of art used to describe deals lasting for days, weeks, or even months.

Nonetheless, the web content offered by the website content server 106 may be displayed on a website 190 such as that represented schematically in FIG. 2. In some examples, the website 190 may be utilized, sponsored, hosted, managed, and/or maintained by a promoter of daily deals. The promoter may use the website 190 to organize and manage deals involving merchants 192, daily deal firms 194, and customers 196, as disclosed below.

Before discussing the website 190 in further detail, however, example methods for generating and promoting daily deals will be described with reference to FIG. 2. More specifically, the merchants 192 in this example include a first merchant 198, a second merchant 200, a third merchant 202, and a fourth merchant 204. Moreover, an abbreviation 206 represents that the first merchant 198 is from a first example region and a first example industry. Another abbreviation 208 represents that the second merchant 200 is from the first region but a second example industry. Likewise, an abbreviation 210 represents that the third merchant 202 is from a second example region but from the first industry. Also, an abbreviation 212 represents that the fourth merchant 204 is from the second region and the second industry. Although only two regions and two industries are used in this example, those having ordinary skill in the art will appreciate that these numbers are only used for purposes of illustration and that the present disclosure contemplates generating and promoting daily deals spanning a multitude of industries and regions.

The example shown in FIG. 2 also includes a number of daily deal firms 194. In particular, the example daily deal firms 194 include a first daily deal firm 214, a second daily deal firm 216, a third daily deal firm 218, and a fourth daily deal firm 220.

As described briefly above, the role of the promoter eliminates inconveniences for both the merchant that does deals with more than one daily deal firm and the daily deal firm that does deals with more than one merchant. For one, the merchant need not interface with a number of different daily deal firms and their respective practices, procedures, management systems, etc. For example, the role of the promoter eliminates the need for the merchant to login to each daily deal firm's coupon management system each time a customer uses a daily deal. Conversely, the daily deal firm need not interface with a number of different merchants.

With continued reference to FIG. 2, a number of example methods of organizing daily deals are possible. In one example, the promoter organizes a daily deal involving merchants from the same industry, but from multiple geographical regions, such as the first and third merchants 198, 202, for instance. One aspect may involve identifying merchants to participate in the daily deal. Another aspect may involve specifying terms of the daily deal such as, for example, identifying a good, a service, or a combination of the good and the service that the first and/or third merchants 198, 202 will be required to perform should a customer purchase the daily deal. The promoter may then have at least one daily deal firm, such as the first daily deal firm 214 and the second daily deal firm 216, distribute the daily deal and at least some of the terms thereof. Two example non-limiting ways to distribute the daily deal are by email and by publishing the daily deal on a website via the World Wide Web. Moreover, in some examples where merchants from different geographical regions are involved, the customer may choose in which geographical region to use the daily deal.

Further, a geographical region may be defined in a number of different ways. For example and without limitation, a geographical region may pertain to a neighborhood, a city, a county, a portion of a state or territory, a state, a group of states, a region of a country, a country, a group of countries, or even a continent, to name a few. Thus, by way of example, the first merchant 198 may be from Southern Wisconsin, and the third merchant may be from Northern Illinois. What's more, while the first and third merchants 198, 202 are from two regions in this example, the multi-region daily deal may involve merchants from many geographical regions in other examples. Likewise, while this example involves only one merchant per region, the multi-region daily deal may in other examples involve a number of merchants from each of the two or more regions. As described above, customers that purchase this type of multi-region daily deal may then select the region in which they would like to use the daily deal.

In still other examples, the present disclosure concerns deals, rather than just daily deals. Thus, deals need not necessarily be sold through a promoter's or daily deal firm's efforts to sell daily deals. Rather, deals may be monetized in other ways. For example and without limitation, a coupon associated with the deal could be distributed to customers in conjunction with another purchase, at no further cost to the customers. For instance, a laundry detergent manufacturer could distribute coupons associated with a deal for discount entry to a number of merchants' paintball fields with its laundry detergent product packaging. The coupons could be in any form such as, for example only, a quick response (QR) code, a password, or a unique number. The detergent manufacturer, recognizing a link between the product and the deal, may subsidize costs of the deal by paying for the coupons up front, expecting that the coupons will thereby garner interest and/or sales of its product. Customers may then, as directed by the coupon, take information from the coupons to the website 190, as described below, and redeem the coupon for a ticket for discounted admission to participating merchants' paintball fields. As part of that process, the website 190 may allow the customer to choose a region or a merchant where the customer wishes to use the ticket. If a region is chosen, the website 190 could then display participating merchants within that region either on the website 190 or on the ticket.

In yet other examples, a deal may be organized by first identifying merchants that wish to participate in a daily deal. A first merchant and a second merchant that wish to participate may be unrelated. In other words, the first and second merchants may be independently owned and associated with different brands. It should be understood that even though at least two merchants are unrelated in such example deals, all of the merchants (e.g., ten merchants) need not necessarily be unrelated. Further, the terms of the deal may be specified, and the deal and/or the terms thereof may be distributed to potential customers. When a customer purchases the deal, the customer may in turn be provided with a ticket that can be redeemed at either the first merchant or the second merchant. In one example, the ticket may include names and contact information for the first and second merchants along with any other participating merchants. In another example, by contrast, the website 190 may ask the user for a selection based on a list of the merchants' names and contact information. Thus, in either example, the customer can choose where to redeem the ticket. In the latter example, though, the customer chooses the merchant at which to redeem the goods or services before receiving the ticket.

In still another example daily deal based on FIG. 2, the promoter organizes a daily deal involving merchants from the same region, but from multiple industries, such as the first and second merchants 198, 200, for instance. Thus, for example only, the first merchant 198 may be in the dinner cruise industry, and the second merchant 200 may be in the comedy club industry. Although merchants from only two industries are used in this example, the present disclosure contemplates deals and daily deals involving merchants from a multitude of industries. With these types of daily deals, the promoter may in some examples provide the customer with one ticket per industry, and in some cases, per person and/or per merchant as well. Thus the customer in this example will receive at least two tickets because there are at least two merchants involved. Moreover, the present disclosure is concerned with, amongst other things, multi-industry deals that involve two experiences, not one experience involving two industries. For instance, one ticket may be redeemed on one day and another ticket may be redeemed on another day. As a further example, one ticket may be redeemed at one location while another ticket may be redeemed at another location. In many cases, the customer decides when and how to redeem the two tickets, as the goods and/or services associated with each industry are not dependent on or intertwined with one another.

With continued reference to FIG. 2, yet another example daily deal involves the promoter organizing a daily deal with merchants from different industries and different regions. Thus the daily deal may involve merchants from at least two industries and merchants from at least two regions. This type of example daily deal could involve as few as two merchants. In most examples, however, numerous merchants are used, spanning several industries and numerous regions.

One having ordinary skill in the art will appreciate that the above examples need not necessarily be performed according to the model shown in FIG. 2. For instance, a daily deal firm could without the assistance of a promoter organize a daily deal involving merchants from multiple regions, multiple industries, or both multiple regions and multiple industries. In some examples, the daily deal firm could organize a daily deal involving multiple unrelated merchants, from the same region or from different regions. In yet another example, as described below, a promoter could offer such daily deals directly to potential customers, rather than going through one or more daily deal firms.

Turning now to FIG. 3, an example flow chart 250 shows several high-level steps that can occur within the life of a daily deal, such as the example daily deals described above. Those having ordinary skill will therefore appreciate that various aspects, features, and/or the like of the example methods of organizing daily deals may be equally applicable to the example website 190 disclosed below. Likewise, various aspects, features, and/or the like disclosed below with respect to the website 190 may be equally applicable to the example methods disclosed above. Further, it should also be understood that each of the steps shown in FIG. 3, or any of the figures for that matter, are merely illustrative. Hence the present disclosure does not by any means necessarily require each and every step.

Nevertheless, the example flow chart 250 in FIG. 3 shows a step 252 where a daily deal is created, a step 254 where the daily deal is distributed and coupons are sold, a step 256 where customers redeem coupons for tickets, a step 258 where customers redeem tickets for goods or services provided by a merchant, and a step 260 where merchants, daily deal firms, and promoters can review statistics associated with the daily deal. In some examples, the website 190 may have a role in each of these steps 252, 254, 256, 258, 260, especially where the daily deal is a direct deal, meaning that the promoter markets the daily deal directly to potential customers without the use of one or more daily deal firms. In other examples, such as where one or more daily deal firms are used to help market the daily deal, the website 190 may not necessarily be involved in the step 254 of distributing the deal and selling coupons to customers. Several of these steps bear further discussion.

With reference to the step 252 of creating a deal, FIG. 4 shows an example non-limiting process 290 through which a daily deal can be created using the disclosed website 190. To begin, a user may log into the website 190 with a username and password, for instance. In the alternative, the user may register for an account if it is the user's first time logging into the website 190. For purposes of this example, the present disclosure will consider the user to be a promoter, in keeping with the examples above. Thus once the promoter logs in, the website 190 may prompt the promoter to choose whether the daily deal will be a direct deal or not, as represented at step 294. If not, the website 190 may prompt the promoter to select a daily deal firm, as represented at a step 296, which will market the daily deal to potential customers. If the daily deal is a direct deal, then the promoter will be responsible for marketing the daily deal. Regardless of whether a daily deal firm is utilized, a next step 298 may involve the promoter specifying some preliminary terms of the daily deal. These terms may include, for instance, run dates, customer prices, quantity for purchase, percentage of revenue for daily deal firm, and the like.

With continued reference to FIG. 4, the website 190 may allow the promoter to select one or more industries to which the daily deal will relate, as shown at a step 300. As disclosed above, in some example daily deals, merchants from only one industry participate. Yet in other example daily deals, merchants from more than one industry participate. Depending on which industry or industries are selected, the website 190 may then ask the promoter to identify specific deal descriptions for webpages, emails, coupons, tickets, and/or the like. In some instances, because some industries have particular acronyms, terms of art, abbreviations, nomenclature, and so on, for example, the promoter may customize the daily deal description as appropriate for the chosen industry or industries. Likewise, the promoter may at this point identify the goods and/or services that are to be provided by participating merchants according to the terms of the daily deal.

Where the daily deal involves multiple industries, the website 190 may next prompt the promoter to enter a number of tickets per coupon per industry, as represented at a step 304. For example, as part of a deal, perhaps a dinner cruise merchant is dealing seats in groups of two while a paintball field is dealing day passes in groups of four. If these two merchants from different industries were part of the same daily deal, the promoter would need to indicate such quantitative information. Likewise, the promoter could specify here whether one ticket should be issued per merchant per industry per person.

In some examples, the promoter may wish to split revenue from sales of the daily deal with, amongst other entities, the participating merchants. As represented at a step 306, the promoter may enter into the website 190 a percentage or an amount (e.g., per ticket) of revenue that should be shared with the merchants within each industry. The shared percentage or amount, if any, may be different depending on the industry, as different industries tend to have different deal structures, protocols, practices, and so on. Still another step 308 may involve the promoter entering into the website 190 expiration dates, which may likewise vary by industry, for coupons and tickets associated with the daily deal. For instance, expiration dates typical in the theatre industry may be shorter than expiration dates typical in the restaurant industry.

Further, based on the industry or industries that the promoter selected in the step 300 in this example, the website 190 may search a database and load a list of regions that have merchants actively doing business in the chosen industry or industries, as represented at a step 310. The database may be a comprehensive listing, a relational database, or even a multidimensional database of merchants that can be sorted, searched, and/or filtered at least by merchant name, by merchant industry, and by merchant region, for example and without limitation. In one example, the database may be stored in the repository 108, as disclosed above. Promoters may add merchants by manually inputting text or by importing spreadsheets containing merchant data. In other examples, merchants can even add themselves to the database. After retrieving such data, the website 190 may display web content such that the promoter can select one or more regions that have merchants within the chosen industry or industries, as represented at a step 312.

It should be understood that even though the website 190 is said to be the device that is performing certain steps (e.g., searching the database), those having ordinary skill in the art will understand that the content server 106 or even one of the user processing devices 102 shown in FIG. 1, which may be associated with the website 190, may in fact be the actual device that is searching the repository 108, retrieving data, and/or rendering such web content. Nevertheless, for the sake of simplicity, the present disclosure refers to the website 190 as performing such steps.

Having received input from the promoter regarding at least one industry and at least one region, the website 190 may search the database and retrieve a list of merchants that are associated with the at least one industry and the at least one region chosen by the promoter, as represented at a step 314. Upon retrieving such data, the website 190 may display web content such that the promoter can select particular merchants that will participate in the daily deal, as represented at a step 316. In one example, the merchants may be listed by industry, and then by region. In the alternative, the merchants may be listed by region, and then by industry. In still another example, the merchants may be listed alphabetically by name, with each merchant name having a region and an industry identifier nearby. The promoter may select merchants based on relationships or conversations with those merchants regarding the proposed deal or daily deal. The website 190 also allows the promoter to choose categories of merchants such as, for example, all merchants within the selected region or regions.

After receiving input as to which merchants will participate in the daily deal, the website 190 may prompt the promoter to choose an order in which the participating merchants will appear on the tickets, as represented by a step 318. In some instances, the promoter may choose to have the merchants at which the ticket can be redeemed appear alphabetically. In other instances involving priorities, certain merchants may insist on being listed first or within the first three merchants, for example.

Still referring to FIG. 4, the process 290 of creating the daily deal may next involve the promoter deciding whether to import its own ticket numbers or have the website 190 auto-generate ticket numbers, as represented at a step 320. Some industries and merchants—and therefore some promoters—prefer their own ticket numbering schemes, or at least recognizable or standardized ticket numbers. Therefore, the website 190 permits the promoter to import ticket numbers for an industry or more than one industry, as represented at a step 322. By contrast, the website 190 is also capable of auto-generating unique numbers that can be associated with each ticket.

Although not shown in FIG. 4, in examples where a daily deal firm is utilized, the website 190 may also provide the promoter with functionality to provide the daily deal firm with coupon numbers before the daily deal goes live. With reference back to the step 256 of FIG. 3, the flow chart 250 represents how a customer redeems a coupon, which is typically issued by the daily deal firm, for one or more tickets, which in turn can be redeemed at a participating merchant. If the promoter does not provide the daily deal firm with coupon numbers in advance, the daily deal firm generates its own coupon numbers and oftentimes the customer attempts to redeem the coupon for a ticket from the promoter before the daily deal firm even provides the promoter with the coupon number for that customer. Thus the promoter has no way of identifying the coupon number issued to the customer, especially considering that daily deals are occurring nowadays in a multitude of industries and regions. By using the website 190 to provide the daily deal firm with coupon numbers in advance, the website 190 will recognize the coupon number when a customer attempts to redeem the coupon for a ticket. And the coupon number will immediately allow the website 190 and hence the promoter to recognize with which daily deal the coupon is associated.

With further reference to FIG. 4, as represented at a step 324, the website 190 may then receive input pertaining to the appearance of a webpage pertaining to the daily deal that is displayed when customers redeem coupons for tickets on the website 190. Thereafter, the website 190 may output all information associated with the daily deal to, for example, a daily deal firm or a website that will distribute relevant information.

As noted above, the process 290 of creating the daily deal does not by any means necessarily include all of these steps. However, in some examples, the process 290 may include all of these steps and additional steps. Moreover, although the steps of the process 290 of creating the daily deal are shown in a particular order, those having ordinary skill in the art will appreciate that many variations in sequence are possible. For example and without limitation, the website 190 may allow the promoter to select regions for a daily deal before selecting industries. Yet further, the website 190 may also permit the promoter to edit existing deals. For instance, the website 190 may present the promoter with a list of existing daily deals that the promoter has organized. The promoter may click on of the existing daily deals to view specifics. Once the promoter opts to view specifics of an existing deal, for examples, the website 190 may provide the promoter with an option to modify the name, terms, etc. of the existing daily deal.

Another step that bears further discussion is the step 256 in FIG. 3 of redeeming coupon for tickets. FIG. 5 shows an example non-limiting process 360 by which the website 190 may be utilized to redeem coupons for tickets. Once a customer purchases a coupon for a daily deal from a daily deal firm, the customer thereafter navigates to the website 190, as represented at a step 362. The website 190 may then receive a coupon number entered by the customer, as represented at a step 364. The website 190 may then determine if the coupon is for a multi-region deal, as represented at a step 366.

If the coupon is in fact for a multi-region deal, the website 190 may identify which regions have participating merchants, as represented at a step 368, and output those regions to the customer as web content, as represented at a step 370. The website 190 then receives the customer's choice as to a preferred region, as represented at a step 372.

Regardless of whether the coupon is for a multi-region deal, the website may next prompt the customer to enter an email address in some examples. This is represented at a step 374 in FIG. 5. Based on the region that the daily deal concerns (i.e., for single region deals) or that the customer selected (i.e., for multi-region deals), the website 190 may in a series of steps determine participating merchants, identify industries involved in the daily deal, and assemble information for the ticket, as represented by steps 376, 378, 380, respectively. In some examples, as represented by a step 382, the website 190 may retrieve from the repository 108 information such as industry-specific deal descriptions, industry-specific images, merchant names, merchant addresses, ticket numbers, and/or QR codes, for example, in preparation for generating a ticket page and URL for each industry for the customer, as represented in a step 384. This information is merely an example of the types of information that may be used to generate a ticket page. For instance, the website 190 may use serial barcodes instead of QR codes.

Nonetheless, in some examples, the website 190 may send an email to the customer with links to one or more industry-specific tickets, as represented by a step 386. When the customer clicks each link, as represented at a step 388, the website 190 may render an industry-specific ticket, as represented at a step 390. The customer may then print each industry-specific ticket, as represented at a step 392. In some examples, depending on preferences of the participating merchants and the promoter, the customer may have the ability to print more than one ticket per piece of paper. However, even in examples where numerous tickets are printed per sheet of paper, the website 190 may provide a unique identifier (e.g., QR codes) for each ticket printed on the sheet of paper. This practice may be advantageous where only three of four expected people appear at a merchant to redeem goods or services. If only one unique identifier exists on the ticket, either the fourth customer loses out or the merchant is left without an easy way to provide the fourth customer with a ticket. Instead, if four unique identifiers are provided on the piece of paper, the merchant can report three redeemed tickets to the website 190 and preserve the validity of the fourth ticket.

As with the other figures, the present disclosure is not by any means limited to the example process 360 shown in FIG. 5. For instance, in still other examples, the website 190 may display links to each industry-specific ticket without ever needing to email the customer. In still other examples involving multi-region, multi-industry deals, customers may be able to redeem tickets for different industries in different regions.

Traditional approaches to daily deals generate coupons and tickets that are generally the same for all customers. Such coupons and tickets list one merchant in one location in one industry. By contrast, the present disclosure concerns a unique ticket for each customer for each industry. Further, for each industry-specific ticket, a list of merchants that are participating in the deal and that are in the region(s) selected by the customer may be included. One example non-limiting process 430 in which to generate a customer-specific, industry-specific, region-specific ticket 432 is shown in FIG. 6, which may further describe several steps of FIG. 5, such as the steps 380, 382, 384, 386, 388, and 390, for example.

With respect to FIG. 6, the example process 430 may begin with the step 386 of emailing the customer a link associated with each industry-specific ticket. Once the customer clicks on one of three example links shown in the step 386, as represented by the step 388, the customer may be routed to web content representing the ticket associated with the chosen link, as represented at a step 434. Next, the website 190 may retrieve and identify a variety of example information for output to the ticket 432. In some examples, part or even all of this information will have been retrieved and assembled by the steps 380, 382 in FIG. 5. Nonetheless, the website 190 may retrieve and output information from the repository 108 pertaining to the particular promoter organizing the daily deal, as represented at steps 436, 438, respectively. Such information may include the promoter's name and logo, for example only. Likewise, the website 190 may retrieve and output industry data, as represented at steps 440, 442. The industry data may, for example and without limitation, include verbiage, images, ticket appearance, ticket layout, abbreviations, acronyms, titles, and/or the like used in the industry. Further, the website 190 may retrieve and output a ticket expiration date, as represented in steps 444, 446, respectively, based on information entered when the promoter created the daily deal. Still further, the website 190 may identify and output merchants that should be listed on the ticket 432, as represented at steps 448, 450, respectively, based, for example, on information entered when the daily deal was created (e.g., participating merchants and industries) and information that the customer has entered (e.g., selected region), if applicable. Yet other example information that may be generated and output to the ticket 432 includes a QR code, as represented at steps 452, 454, respectively. The customer may then print the ticket(s) or maintain the ticket(s) on a mobile device, for example, until redemption.

Although the process of redeeming coupons for tickets has been described, coupons may be redeemed directly for a merchant's goods and/or services in some examples. Thus in some examples, coupons may serve as tickets or may be referred to as tickets. An example benefit to converting coupons to tickets, however, is that more standardized tickets can be used that are more easily recognized by merchants than coupons coming from a number of different daily deal firms. This benefit complements the benefit provided to merchants of only having to interface with the promoter rather than a number of daily deal firms. Still another advantage of converting the coupon is that this process allows more than one ticket to be generated. Similar to the situation described above, it can be difficult for a merchant to memorialize that only three of four tickets were used when only one coupon exists representing four tickets, for example.

Still other example features are not necessarily shown in the figures. In one example, the website 190 may include supplemental offers on the tickets that customers use at merchants. After a customer purchases a daily deal, a merchant can exploit the customer's interest in the merchant because the customer is at least a partially-captivated audience. For instance, perhaps an amusement park-merchant participated in a daily deal that sold many tickets to customers. The amusement park, hoping to capitalize when those customers redeem their tickets at the park, may choose to include a supplemental offer on the ticket for 30% off food within the park. Such supplemental content may be input to the website 190 at the time the deal is created, or at any point thereafter before all of the customers redeem coupons for tickets. Still other examples may involve promotion codes for online retailers. In some examples, supplemental offers may have expiration dates that coincide with the expiration date of the ticket, encouraging the customer to take advantage of the supplemental offer while convenient or while they have the opportunity. In other examples, though, supplemental offers may have their own expiration dates independent of any expiration date associated with the ticket, which may encourage customers to return to the merchant at some other point in time. What's more, terms of these supplemental offers and, where applicable, an ability to accept the supplemental offers may be viewed by following a link provided with or printed on the original ticket.

In yet other examples, the supplemental offers may be part of the original daily deal. For instance, the terms of a daily deal may specify that for $30, customer can purchase a coupon for $40 worth of merchandise from a women's online apparel retailer as well as 30% off sales on a future date within the next two months. Moreover, the coupon may in some examples be redeemed at the website 190 for two tickets, one ticket for the $40 worth of merchandise, and a second ticket for the 30% off sales on a future date.

Thus once customers have their tickets, the customers can redeem their tickets at participating merchants according to the terms of the daily deal. To verify that the ticket is valid, the merchants may enter ticket numbers, scan QR codes, or input other unique identifiers from the ticket into the website 190. The website 190 may be accessed via virtually any mobile device, computer, and/or the like having connectivity to the network 104. In some examples, merchants may access the website 190 by an example mobile device application. Another example reason why merchants may wish to use the website 190 to record redeemed tickets is to enable the website 190 to generate statistics for the merchant. Yet a further example reason is because the merchant may be receiving a percentage of revenue from sales of the daily deal. Moreover, because the website 190 may have the name and email address of only the customer that purchased the daily deal, merchants may be able to enter information into the website 190 when the customer redeems the tickets with other individuals. This information may include the names and email addresses, for example, of the other individuals that are using tickets associated with the daily deal that the customer purchased.

Another aspect to the website 190 may involve tracking number of tickets sold, number tickets redeemed, revenue, quantities of tickets sold, quantities of tickets redeemed, deal dates, expiration dates, numbers of customers, and/or the like by merchant, by industry, by region, by daily deal firm, by deal, etc. The website 190 may allow merchants to view charts, graphics, tables, and other visual aids representing, for example and without limitation, numbers of tickets redeemed at that merchant that were attributable to one or more daily deals, or a flow of ticket redemptions at that merchant by date for one or more deals. In another example, a merchant that participated in a daily deal can view a percentage of tickets that were redeemed at the merchant's venue as opposed to other merchants' venues that participated in the daily deal. In one example, the website 190 may update these statistics immediately upon receiving information such as ticket numbers or QR codes indicating that customers redeemed tickets at a particular merchant. Further, the website 190 may display any revenue kickbacks from sales of daily deals, identities and contact information of new customers, and/or numbers and contact information of any “followers.” In general, the merchant can at any point in time (e.g., while the daily deal is on sale or thereafter) log into the website 190 and view, for example only, a number of coupons that have been sold, a number of coupons that have been redeemed, and a number or percentage of tickets that have been redeemed at the merchant's venue versus other merchants' venues. The website 190 may also provide the ability for merchants and/or promoters to track, sort, and/or filter all tickets and/or coupons according to one or more of the following, as applicable: daily deal, promoter, merchant, daily deal firm, timeframe, industry, geographical region, customer, and the like, for example.

By way of specific example, FIG. 7 shows an example merchant interface 500 that a merchant can use to analyze performance based on one or more deals. In one example, the merchant interface 500 may include a dropdown box 502 that allows the user to switch between merchants if the user's account is associated with more than one merchant. A “refresh” button 504 may permit the user of the website 190 to update the content of the merchant interface 500 based on filters set or selections made by the merchants. In other examples, though, the merchant interface 500 may update automatically after the user makes selections, without any request from the user. Further, the merchant interface 500 includes another dropdown box 506 that allows the user to modify the time period from which data is shown. Example periods of time may include the last three months, the last year, the last five years, or the lifetime of the user's account.

The example merchant interface 500 in FIG. 7 also includes first and second graphs 508, 510. The first graph 508 displays a number of tickets sold by a particular promoter for the last six months for deals in which the selected merchant was participating. The second graph 510 shows a number of tickets that were redeemed at the selected merchant's venue for the last six months based on deals that were organized by the promoter.

The example merchant interface 500 further shows revenue 512 for the merchant based on deals in which the merchant participated, which are shown in a chart 514 below. In this example, the deals on which the revenue 512 is based pertain only to the promoter. In other examples, however, the merchant can display aggregate statistics across numerous promoters with which the merchant has done deals. Likewise, the merchant can choose to view statistics and graphs associated with another promoter's deals in which the merchant participated. Also shown in this example merchant interface 500 is a number of new customers 516 based on a period selected by the merchant in the dropdown box 506. The number of new customers 516 may be configured so as not to count repeat customers.

With regard to the chart 514, a variety of information can be shown. In the example chart 514 of FIG. 7, this information includes a name of the deal 518, a deal number 520, an offer start date 522, an offer end date 524, a coupon expiration date 526, a number of tickets sold 528, a number of tickets redeemed at the selected merchant's venue 530, an amount earned through sales of the deal 532, an amount of additional revenue 534, an amount of total revenue 536, a number of new customers 538, and a link to view the customers 540. The information in the chart 514 may be sorted and/or filtered in many different ways, although in FIG. 7 this information is shown to be sorted by the name of the deal 518. The name of the deal 518 and the deal number 520 are only two example ways to identify deals.

Turning to FIG. 8, an example promoter interface 580 is shown. Similar to the merchant interface 500, the promoter interface in this example has a first graph 582 and a second graph 584. Those having ordinary skill in the art will appreciate that some features described with reference to one interface may be equally applicable to another interface, even though such features are not necessarily shown or described with reference to both of the example interfaces shown in FIGS. 7-8. That said, the first graph 582 in FIG. 8 shows a quantity of tickets sold through deals organized by a particular promoter within the last six months. The second graph 584 shows a number of tickets redeemed through deals organized by the promoter within the last six months.

The promoter interface 580 further includes a revenue-to-date statistic 586. In some examples, the promoter interface 580 may indicate to the user the criteria, or lack thereof, upon which the revenue statistic 586 has been filtered. Here, the statistic 586 is based on all deals that the promoter has organized. What's more, the promoter interface 580 may allow promoters to filter their statistics and the first and second example graphs 582, 582 according to at least one region 588, at least one daily deal firm 590 (where applicable), at least one merchant 592, at least one industry 594, and/or a timeframe 596, for instance. In some examples, the promoter interface 580 may only display those regions 588, firms 590, merchants 592, and/or industries 594 for which data exists.

The promoter interface 580 may in some examples include a chart 598 similar to that shown in the example merchant interface 500. The chart 598 shown in FIG. 8, however, includes a name of the deal 600, a deal number 602, an offer end date 604, a coupon price 606, a number of coupons sold 608, an amount of promoter revenue 610, an amount of merchant revenue 612, and an amount of additional merchant revenue 614, for instance. The information in the chart 598 may be likewise be sorted and/or filtered in many different ways, although in FIG. 8 this information is shown to be sorted by the name of the deal 600.

Still another example feature of the website 190 may involve providing promoters, merchants, or both merchants and promoters with the ability to send emails or texts to customers. Such messages may be used in several contexts such as sending automated thank you messages to customers, creating specials for loyal customers, sending important announcements, and requesting feedback, for example. With respect to the automated thank you emails or texts, for instance, messages may be sent as soon as the unique identifier on the ticket is entered into the website 190. In another example, however, the automated thank you messages may be sent several hours or a day after the unique identifier on the ticket is entered into the website 190. Moreover, the website 190 may send automated thank you emails or texts to those customers that provide information to a merchant when the tickets associated with the daily deal are redeemed.

As disclosed above, the website 190 has the capability to auto-generate coupon numbers in examples where daily deal firms are used. The coupon numbers are then used as unique identifiers on the coupons that customers purchase from the daily deal firm. In some examples, therefore, the website 190 can embed tracking cookies and a link back to the website 190 in the coupon number. The tracking cookies may track an email that the customer enters at the daily deal firm's website. Once the customer clicks on the coupon number, the customer may automatically be redirected to the website 190. There, the website 190 may auto-fill and/or auto-complete the process of redeeming the coupon for a ticket for the customer based on the coupon number and the customer's email address. If the customer purchased a multi-region daily deal, the only information that the customer would need to enter at the website 190 is the region or regions in which the customer would like to use the daily deal. Thereafter, or if the customer purchased a single-region deal, the website 190 could either send an email with a link to the tickets or route the customer directly to a webpage where the customer could obtain tickets, for printing or storing on a processing device. As those having ordinary skill in the art will appreciate, the customer would in some examples need to consent to the tracking of the email address (e.g., through the acceptance terms and conditions of the daily deal firm).

While various concepts have been described in detail, it will be appreciated by those of ordinary skill in the art that various modifications and alternatives to those concepts could be developed in light of the overall teachings of the disclosure. For example, while various aspects of the present disclosure have been described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each aspect of the disclosure is not necessary for an enabling understanding of the disclosure. Rather, the actual implementation of the systems and methods would be well within the routine skill of an engineer, given the disclosure herein of the attributes, functionality, and inter-relationship of the various components in the system. Therefore, a person of ordinary skill in the art will be able to practice the disclosure set forth in the claims without undue experimentation. It will be additionally appreciated that the particular concepts disclosed are meant to be illustrative only and not limiting as to the scope of the disclosure which is to be given the full breadth of the appended claims and any equivalents thereof.

We claim:

1. A method of promoting a multi-industry daily deal, the method comprising steps of:
identifying a first merchant from a first industry and a second merchant from a second industry to participate in a daily deal;
specifying terms of the daily deal, wherein at least one of the terms of the daily deal calls for each of the first and second merchants to provide a good, a service, or a combination of the good and the service;
distributing at least a portion of the terms of the daily deal; and
providing a customer with a first ticket redeemable at the first merchant and a second ticket redeemable at the second merchant.

2. A method of promoting a multi-industry daily deal as recited in claim 1, wherein the first ticket is redeemable at the first merchant at a first location, wherein the second ticket is redeemable at the second merchant at a second location.

3. A method of promoting a multi-industry daily deal as recited in claim 1, wherein the first ticket is redeemable at the first merchant on a first day, wherein the second ticket is redeemable at the second merchant on a second day.

4. A method of promoting a multi-industry daily deal as recited in claim 1, further comprising providing the customer with a single coupon that is redeemed for the first and second tickets.

5. A method of promoting a multi-industry daily deal as recited in claim 1, further comprising identifying a third merchant from the first industry and a fourth merchant from the second industry to participate in the daily deal, wherein the first and second merchants are from a first geographical region, wherein the third and fourth merchants are from a second geographical region.

6. A non-transitory computer readable media having stored thereon instructions which, when executed by a computer, perform steps comprising:
providing a user of a website with a list of merchants;
receiving input from the user regarding a deal, the input including a selection of a first merchant and a second merchant to participate in the deal, wherein the first merchant is from a first industry and the second merchant is from a second industry; and
generating for a customer of the deal a first ticket redeemable at the first merchant and a second ticket redeemable at the second merchant.

7. A non-transitory computer readable media as recited in claim 6, wherein the first ticket is redeemable by one person for a first good, a first service, or a first combination of the good and the service at the first merchant, wherein the second ticket is redeemable by one person for a second good, a second service, or a second combination of the good and the service at the second merchant.

8. A non-transitory computer readable media as recited in claim 7, further comprising providing the customer with a single coupon that is redeemable for the first and second tickets, wherein the first ticket is redeemable at the first merchant on a first day at a first location, wherein the second ticket is redeemable at the second merchant on a second day at a second location.

9. A non-transitory computer readable media as recited in claim 6, further comprising identifying a third merchant from the first industry and a fourth merchant from the second industry to participate in the deal, wherein the first and second merchants are from a first geographical region, wherein the third and fourth merchants are from a second geographical region.

10. A method of promoting a deal, the method comprising steps of:
identifying a first merchant and a second merchant to participate in a deal, wherein the first and second merchants are independently owned, wherein the first merchant is associated with a first brand and the second merchant is associated with a second brand;
specifying terms of the deal, wherein at least one of the terms of the deal calls for the first merchant or the second merchant to provide a good, a service, or a combination of the good and the service;
distributing at least one of at least a portion of the terms of the deal or a coupon associated with the deal; and
providing a customer with a ticket that is redeemable at the first merchant or the second merchant based on a choice of the customer.

11. A method of promoting a deal as recited in claim 10, wherein the ticket is provided to the customer after the customer has chosen whether to receive the good, the service, or the combination of the good and the service at the first merchant or the second merchant.

12. A method of promoting a deal as recited in claim 10, wherein the ticket includes information pertaining to both the first merchant and the second merchant, wherein the ticket can be redeemed at either the first merchant or the second merchant based on the choice of the customer.

13. A method of promoting a deal as recited in claim 10, wherein a third party subsidizes at least a portion of a cost of the deal, wherein the first merchant is from a first geographical region, wherein the second merchant is from a second geographical region.

14. A method of promoting a deal as recited in claim 10, wherein the choice of the customer involves deciding whether to receive the good, the service, or the combination of the good and the service in a first geographical region or a second geographical region, wherein the first merchant is from the first geographical region and the second merchant is from the second geographical region.

15. A method of promoting a deal as recited in claim 14, wherein the ticket is provided to the customer after the customer has chosen whether to receive the good, the service, or the combination of the good and the service in the first geographical region or the second geographical region.

16. A method of promoting a deal as recited in claim 10, comprising distributing the coupon associated with the deal, wherein the coupon is redeemable for the ticket.

17. A non-transitory computer readable media having stored thereon instructions which, when executed by a computer, perform steps comprising:
providing a user of a website with a list of merchants;
receiving input from the user regarding a deal, the input including a selection of a first merchant and a second merchant to participate in the deal, wherein the first and second merchants are independently owned and associated with different brands; and
generating a ticket for a customer that purchases the daily deal, wherein the ticket is redeemable at the first merchant or the second merchant.

18. A non-transitory computer readable media as recited in claim 17, wherein the ticket includes information pertaining to both the first merchant and the second merchant, wherein the ticket can be redeemed at either the first merchant or the second merchant based on a choice of the customer.

19. A non-transitory computer readable media as recited in claim 17, further comprising providing the customer with a choice before generating the ticket as to whether to receive a good, a service, or a combination of the good and the service in a first geographical region or a second geographical region, wherein the first merchant is from the first geographical region and the second merchant is from the second geographical region.

20. A non-transitory computer readable media having stored thereon instructions which, when executed by a computer, perform steps comprising:
receiving data from merchants that is indicative of a quantity of customers that have redeemed tickets, wherein each redeemed ticket is associated with one of the merchants and with a deal;
displaying a merchant interface on a website that at least shows information regarding a number of tickets that were redeemed at a first merchant, wherein the merchant interface includes at least one of a graph or a chart, wherein the information regarding the number of tickets that were redeemed at the first merchant is at least one of filterable or sortable by at least one of a daily deal firm or a customer.

21. A non-transitory computer readable media having stored thereon instructions which, when executed by a computer, perform steps comprising:
receiving data from merchants that is indicative of a quantity of customers that have redeemed tickets, wherein each redeemed ticket is associated with one of the merchants and with a deal organized by a promoter;
displaying a promoter interface on a website that at least shows information regarding the quantity of customers that have redeemed tickets, wherein the information regarding the quantity of customers that have redeemed tickets are at least one of filterable or sortable by at least one of a deal, a geographical region, a daily deal firm, a merchant, a timeframe, or an industry.
